(19) United States
(12) Patent Application Publication
(10) Pub. No.: US 2012/0097127 A1
(43) Pub. Date: Apr. 26, 2012

(54) Separate igniter fuel injection system

(76) Inventor: Joseph Carl Firey, Seattle, WA (US)

(21) Appl. No.: 12/925,541

(22) Filed: Oct. 25, 2010

(51) Int. Cl. F02M 43/04

(52) U.S. Cl. 123/304

(57) ABSTRACT

A separate igniter fuel injection system is described for use with diesel engines operating on tar based slurry fuel with a common rail slurry fuel injection system. The igniter fuel is injected prior to injection of the slurry fuel, during each engine compression stroke, so that the ignition and burning of the igniter fuel will supply hot gases for the evaporation and thermal cracking needed to ignite the tar fuel portions of the slurry. This separate igniter fuel injection system can also be used for cold startup of a diesel engine operated on tar based slurry fuels.

### CROSS REFERENCES TO RELATED PATENTS AND APPLICATIONS

The invention described herein is related to my following US patent applications:
(1) U.S. Pat. No. 6,444,000, entitled, Steam Driven Fuel Slurrifier, issued 8 Sep. 2002.
(2) U.S. Pat. No. 7,677,791, entitled, Rotary Residual Fuel Slurrifier, issued 16 Mar. 2010.
(3) U.S. patent application Ser. No. 12/583,448, entitled, Rotary Tar Slurrifier, filed 21 Aug. 2009.

The above patents and applications describe apparatus for preatomizing high viscosity tars and residual fuels.
(4) U.S. Pat. No. 7,281,500, entitled, Supplementary Slurry Fuel Atomizer and Supply System, issued 16 Oct. 2007.
(5) U.S. Pat. No. 7,418,927, entitled, Common Rail Supplementary Atomizer for Piston Engines, issued 2 Sep. 2008.
(6) U.S. patent application Ser. No. 12/011,569, entitled, Modified Common Rail Fuel Injection System, filed 19 Jan. 2008.

The above patents and applications describe the use of contactor chambers and separate hydraulic fluid common rail for dissolving supplementary atomizing gas into the continuous phase of a slurry fuel.
(7) U.S. patent application Ser. No. 12/454,640, entitled, Engine Fuels from Coal Volatile Matter, filed 21 May 2009.
(8) U.S. patent application Ser. No. 12/590,333, entitled, Cyclic Batch Coal Devolatilization apparatus, filed 6 Nov. 2009.
(9) U.S. patent application Ser. No. 12/653,189, entitled, Engine Fuels from Coal and Biomass Volatile Matter, filed 10 Dec. 2009.

These latter patent applications describe apparatus for deriving high viscosity fuels and tars, suitable for slurrification into slurry fuels from our large reserves of bituminous coal and also from non food farm harvest biomass materials.
(10) U.S. patent application Ser. No. 12/799,209, Common Rail Slurry Fuel Injection System, filed 21 Apr. 2010.

### BACKGROUND OF THE INVENTION

Currently fuel injection systems, used on diesel engines, are required to carry out two necessary functions: atomize the fuel into the many small particles needed for rapid and efficient burning of the fuel; and distribute these many fuel particles approximately uniformly in the air mass in the engine combustion chamber, so that each fuel particle has access to the air needed for combustion. When lower cost, higher viscosity, fuels are to be used, higher fuel injection pressures, and resulting higher fuel jet velocities are needed, in order to achieve the needed small fuel particle sizes. At higher velocity, the fuel jet penetrates deeper across the engine combustion chamber. Thus to avoid fuel jet impact on the engine cylinder wall, larger engine cylinder diameter is needed when higher viscosity fuels are to be used.

For these reasons low cost, high viscosity, petroleum residual fuels and tar fuels are currently used only in large bore, very slow speed, marine diesel engines for cargo ships. The small bore, high speed, diesel engines, and medium bore, medium speed, diesel engines, used throughout our commercial surface transportation and farm system, are obliged to use expensive, low viscosity petroleum distillate fuels to avoid inefficient fuel combustion.

A principle beneficial object of the common rail slurry fuel injection systems described in my earlier filed U.S. patent application entitled, Common Rail Slurry Fuel Injection System, Ser. No. 12/799,209, filed 21 Apr. 2010, is to provide an efficient method for operating medium and high diesel engines on high viscosity, low volatility, low cost, fuels, such as tars from Athabaska tar sands, coal tars, biomass tars, and residual petroleum fuels.

The invention described in my above referenced US patent application can be outlined at follows:

Preatomizing a high viscosity tar or residual fuel, outside the diesel engine combustion chamber, into a slurry fuel comprising many small fuel particles, preatomized into a suspension within a continuous water phase, relieves the fuel injection system of the duty of atomizing the high viscosity fuel. The slurry fuel injection system can then be primarily designed to distribute these many small fuel particles, within the compressed combustion air mass in the engine cylinder, for optimum efficiency of combustion and engine work output.

During slurry fuel injection into the engine combustion chamber, aerodynamic forces will break up the slurry fuel jet into separate primary slurry fuel droplets, each of which will contain many separate preatomized fuel particles. The water phase evaporates from the surface of the slurry fuel primary droplets, thus leading to reagglomeration of the preatomized fuel particles into larger particles.

To avoid this undesirable reagglomeration of fuel particles, as well as to accelerate the water evaporation step, water soluble supplementary atomizing gas is dissolved into the continuous water phase of the slurry, at high pressure in a contactor chamber added to the common rail fuel injection system of this invention. When slurry fuel, containing supplementary atomizing gas, dissolved into the continuous phase at the high pressure in the contactor chamber, is injected into the relatively low pressure in the engine combustion chamber, the supplementary atomizing gas will expand out of solution in each primary slurry droplet, and separate the preatomized fuel particles, thus preventing undesirable reagglomeration of fuel particles.

In this common rail fuel injection system, two separate valves are interposed between the high pressure common rail and the fuel injection spray nozzle in order to take pressure off of the fuel injection valve between injections, and thus reduce the possibility of fuel leakage during engine exhaust and intake. Both the fuel injection valve and the separate fuel shut off valve are often opened and closed using the engine fuel from the common rail as a driving fluid. For the slurry fuel injection system of this invention a separate hydraulic fluid, at high pressure in a hydraulic fluid common rail, is used as the driving fluid for the opening and closing of both the fuel injection valve and the fuel shut off valve. Slurry fuel containing dissolved supplementary atomizing gas is thus not used for driving the fuel injection valve and the fuel shut off valve of this invention and the loss of compressed atomizing gas which would otherwise result is avoided.

After each fuel injection, any fuel trapped between the closed fuel injection valve and the closed fuel shut off valve is to be depressurized to avoid fuel leakage. For conventional distillate petroleum fuels such depressurization, even of a large fuel volume, does not create a problem. But, for a slurry fuel containing dissolved supplementary atomizing gas, either depressurization is incomplete due to pressure created by expanding atomizing gas, or, if the fuel injection valve is last to close, any appreciable trapped slurry fuel portion loses the benefit of supplementary atomizing gas before being injected into the engine cylinder. For the slurry fuel injection system of this invention a special double valve fuel injector is used wherein the fuel shutoff valve and fuel injection valve, while operated separately, have a common sealing surface edge. As a result the volume of fuel trapped between these two valves can be vanishingly small.

Tar fuels and residual petroleum fuels are also slow to react with hot compressed air during compression, and this long ignition delay period requires use of low engine speeds. A small portion of high cetane number distillate petroleum igniter fuel particles can be added to the tar fuel in water slurry in order to obtain the shorter ignition delay period required for use in medium and high speed diesel engines.

Nevertheless, the compression ignition of the igniter fuel particles is additionally delayed by the time needed for completion of the supplementary atomization step before the needed air can reach and react with the igniter fuel particles in the slurry.

### Separate Igniter Fuel Injection System: Summary of the Invention

The improvement invention described herein is a combination of a separate igniter fuel injection system, added on to a diesel engine, equipped with a common rail slurry fuel injection system. The common rail slurry fuel injection system utilizes a combined double valve slurry fuel injector, operated by a hydraulic fluid common rail, separate from the slurry fuel common rail, as described in my earlier filed U.S. patent application entitled, Common Rail Slurry Fuel Injection System, Ser. No. 12/799,209, filed 21 Apr. 2010. A small quantity of a volatile, high cetane number igniter fuel is injected, via this separate igniter fuel injection system into the engine combustion chambers, during each engine compression stroke, and prior to the injection of the tar containing slurry fuel thereinto. The early compression ignition of the small portion of igniter fuel creates high temperature gas and pressure waves, which promote rapid fuel evaporation and thermal cracking, of the tar like slurry fuel particles and consequent more rapid and more complete burnup of the slurry fuel, which is the principal engine fuel. The resulting improved engine efficiency and reduced soot emissions are a principal beneficial object of this improvement invention.

The small igniter fuel quantity used to improve combustion during normal engine running can be sufficiently increased during engine cold starting to supply all of the energy needed to start the diesel engine when cold. This is an additional beneficial object of this invention.

### BRIEF DESCRIPTION OF THE DRAWINGS

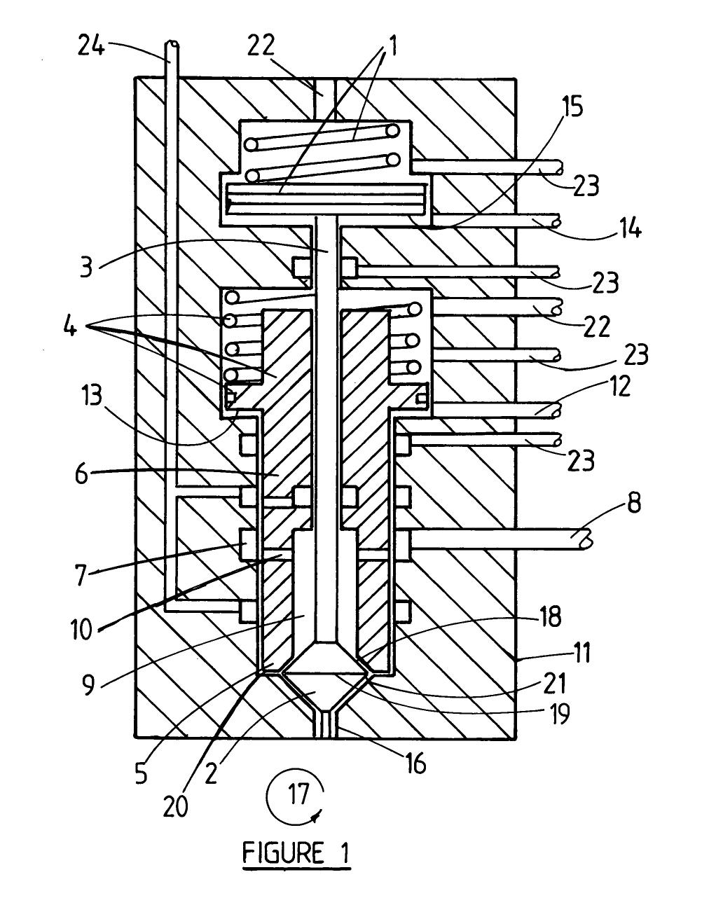

A schematic cross sectional drawing of a combined double valve slurry fuel injector is shown on FIG. 1. The common valve seat edge, 21, of the igniter fuel injection, valve 2, and the igniter fuel shutoff valve, 5, is shown in FIG. 1.

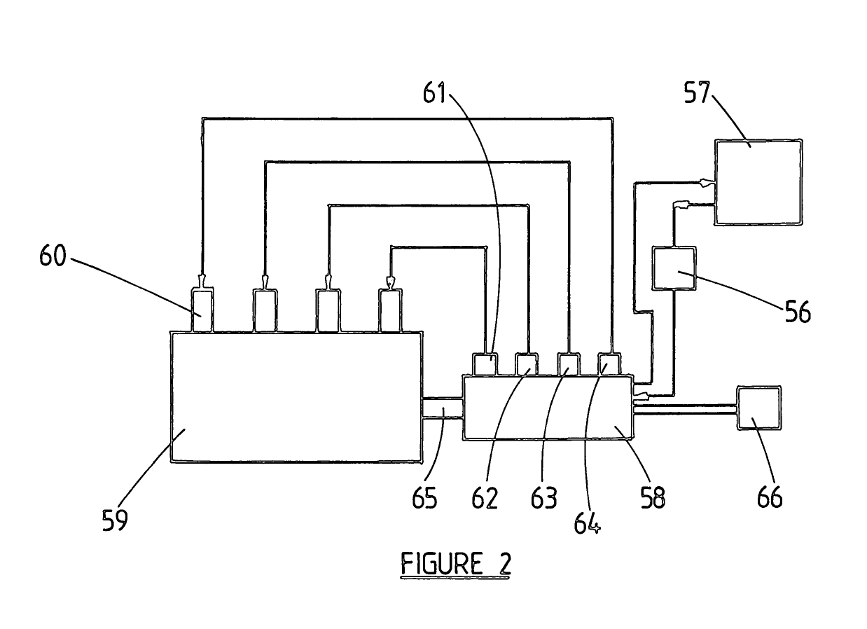

A schematic diagram of a conventional Bosch igniter fuel injection system is shown in FIG. 2 for a two stroke cycle diesel engine.

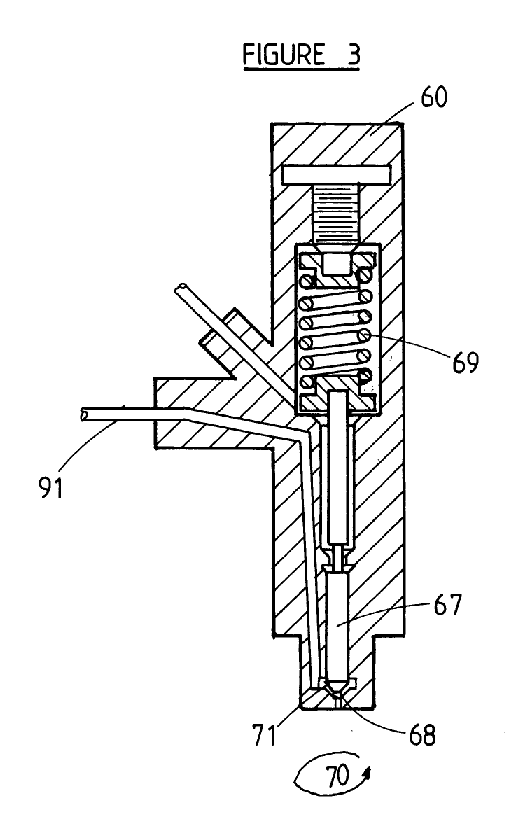

A typical example Bosch igniter fuel injector is shown in cross section on FIG. 3.

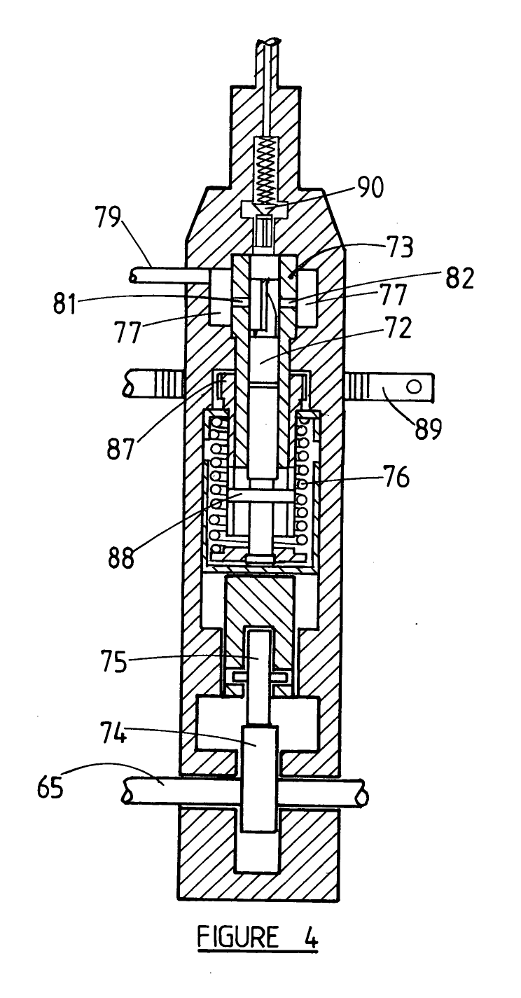

A typical example Bosch igniter fuel pump is shown in cross section on FIG. 4.

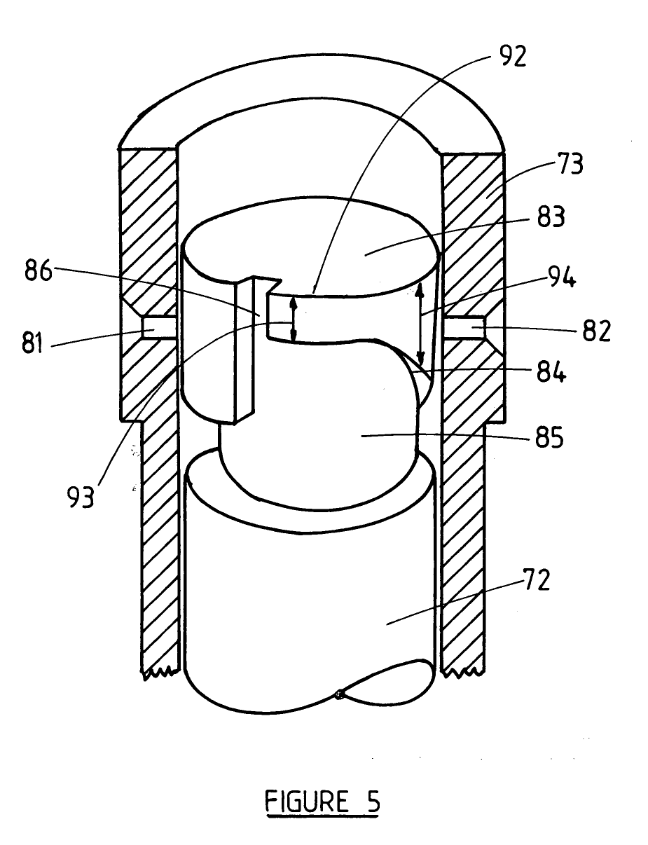

The modified helical curved upper edge, 84, of the reduced diameter portion 85, of the Bosch igniter fuel pump plunger, 72, is shown in more detail in FIG. 5.

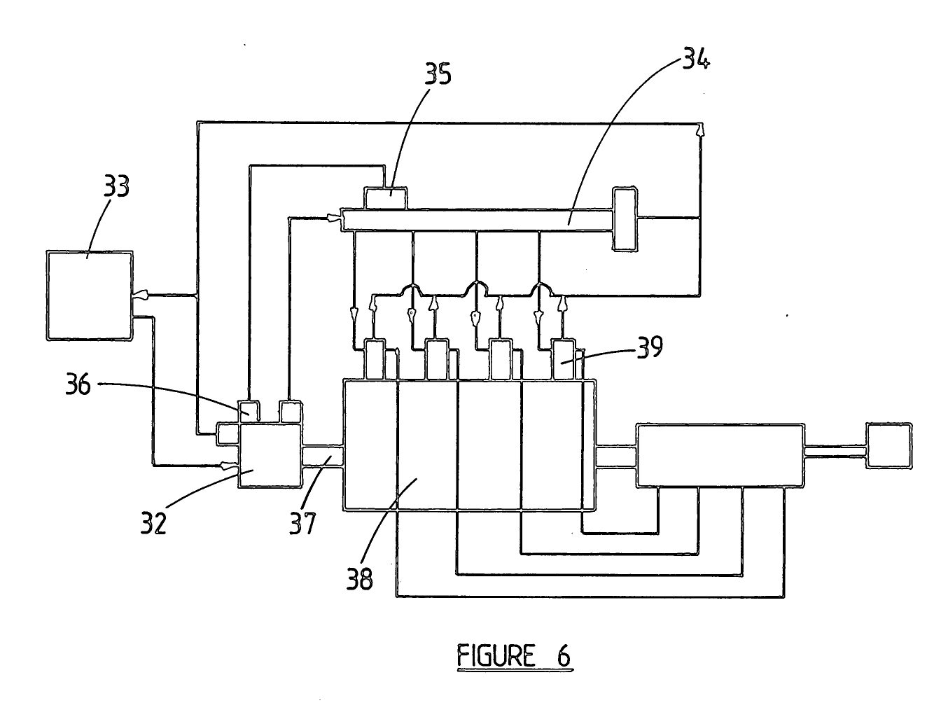

An example igniter fuel common rail fuel injection system, for a two stroke cycle diesel engine, is shown schematically in FIG. 6.

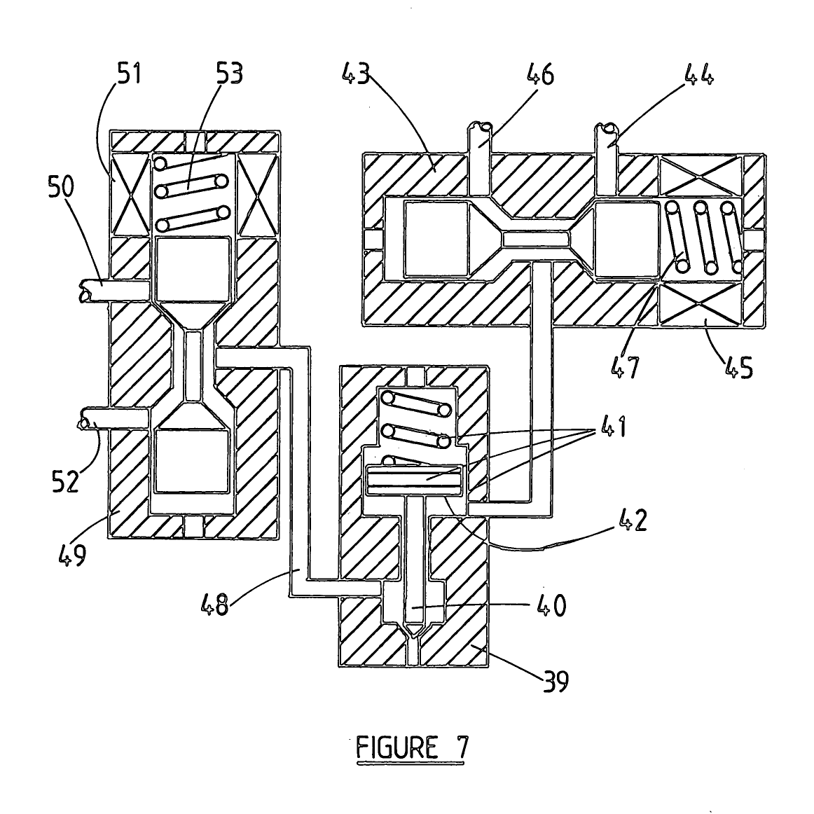

One type of igniter fuel injector, for use with a common rail igniter fuel injection system such as shown in FIG. 6, is shown in cross section in FIG. 7.

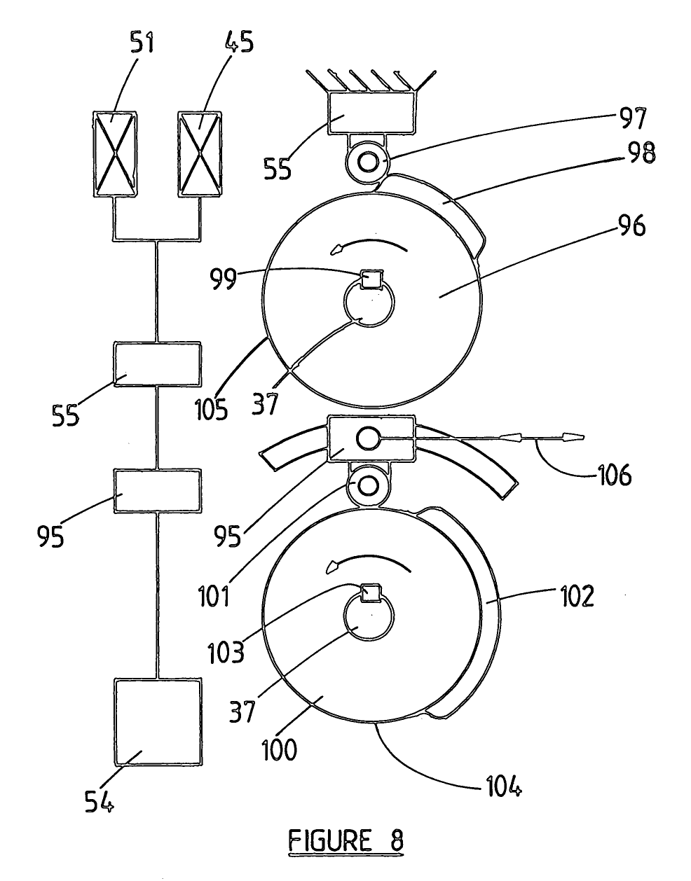

An electrical switch and cam timer system for use with a common rail igniter fuel injection system is shown schematically in FIG. 8.

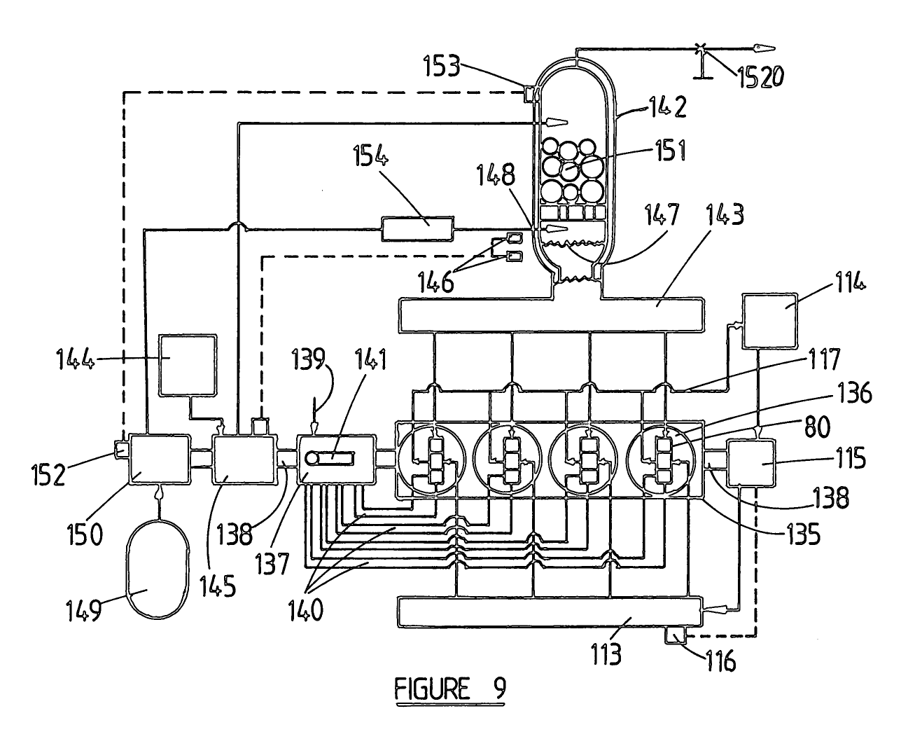

An example common rail slurry fuel injection system, using a contactor chamber to 0.8 dissolve supplementary atomizing gas into the continuous phase of the slurry fuel is shown schematically in FIG. 9.

None of the drawings are to scale.

Separate Igniter Fuel injection System Description of the Preferred Embodiments

All forms of the invention described herein are an improvement on the invention described in my earlier filed US patent application entitled, Common Rail Slurry Fuel Injection System, Ser. No. 12/799,209, filed 21 Apr. 2010, and this material is incorporated herein by reference thereto. The improvement comprises adding to the engine a separate igniter fuel injection system, which injects a small quantity of a high cetane number igniter fuel, into each engine combustion chamber, driving each piston compression stroke, and prior to the engine of a larger quantity of slurry fuel thereinto by the Common Rail Slurry Fuel Injection System referred to above. Compression ignition and burning of this small igniter fuel quantity supplies hot gas, and pressure waves, to promote the subsequent evaporation and thermal cracking of the tar-like fuel particles from the slurry fuel. In this way the combustion of the slurry fuel is more rapid and more complete, with resulting improvement in engine fuel efficiency and reduction of soot particle generation and emission during each engine exhaust process; and this is a principal beneficial object of this invention.

When the engine is to be cold started, this same igniter fuel injection system can be used to inject an appreciably larger igniter fuel quantity, whose ignition and combustion will create an engine work output sufficient to overcome engine friction, and the engine can be started, and this is an additional beneficial object of this invention.

A wide variety of diesel engine fuel injection systems can be used for this separate igniter fuel injection system, in combination with the several common rail slurry fuel injection systems described in the incorporated referenced US patent application entitled, Common Rail Slurry Fuel Injection System. One example common rail slurry fuel injection system is described hereinbelow and two different example igniter fuel injection systems, a Bosch type igniter fuel injection system, and a common rail type igniter fuel injection system, are also described hereinbelow.

### Description of Example Slurry Fuel Injection System

The example slurry fuel injection system shown schematically in FIG. 9 is operative in a four cylinder, two stroke cycle diesel engine, 135, and comprises the following principal elements:
(1) The combustion chamber in each of the four engine cylinders, 136, are equipped with a combined double valve fuel injector, 80, details of which are described hereinbelow.
(2) An electronic fuel injection timer unit, 137, is timed by the engine crankshaft 138, and energized by an electric power source, 139. Pressure and vent valves are operated by the electronic timer unit, 137, to open and close the combined double vale slurry fuel injector, 80, and connect to the electronic timer unit, 137, via electric cables, 140. The torque control lever, 141, introduces an adjustable time interval between the electronic power pulse, which opens the fuel injection valve, and the subsequent electronic power pulse, which closes the fuel shutoff valve, in order to adjust the slurry fuel quantity injected per engine cycle, and thus to control engine torque;
(3) High pressure hydraulic fluid is delivered to the pressure connections of each pressure and vent valve from the high pressure hydraulic fluid common rail, 113, which receives hydraulic fluid from the hydraulic fluid tank, 114, via the hydraulic fluid high pressure pump, 115, driven from the engine crankshaft, 138, and controlled by the pressure sensor, 116, on the high pressure hydraulic fluid common rail, 113. Vented hydraulic fluid from the pressure and vent valves is returned to the hydraulic fluid tank, 114, via vent pipe, 117, to complete the hydraulic fluid cycle.
(4) The slurry fuel contactor chamber, 142, for contacting slurry fuel with supplementary atomizing gas, is open flow connected to the high pressure slurry fuel common rail, 143. Slurry fuel from the slurry fuel tank, 144, is delivered into the upper portion of the contactor chamber, 142, by the high pressure slurry fuel pump, 145, driven by the engine crankshaft, 138. Slurry fuel is delivered into the contactor chamber above the packing material, 151, therein, and flows downward over the large area of the packing material into the bottom portion of the contactor chamber. The pump, 145, is controlled by the sensors, 146, of slurry fuel level, 147, within the contactor chamber, 142, to maintain an essentially constant fluid level therein, below the level, 148, at which supplementary atomizing gas is delivered into the lower portion of the contactor chamber, 142.
(5) Carbon dioxide gas is used as supplementary atomizing gas, for this FIG. 9 example slurry fuel injection system, and is pumped, from the carbon dioxide tank, 149, by the supplementary atomizing gas compressor, 150, into the lower portion of the contactor chamber, 142, but above the fluid level, 147, therein. The carbon dioxide supplementary atomizing gas flows upward, through the packing material, 151, in the contactor chamber, countercurrent to the downward flow of slurry fuel. Much of the carbon dioxide will become dissolved into the continuous water phase of the slurry fuel. Undissolvable gas impurities and a small portion of carbon dioxide will leave the top of the contactor chamber, 142, via the small flow area gas bleed nozzle, 1520.
(6) A high and essentially constant pressure is maintained within the contactor chamber, 142, and the slurry fuel common rail, 143, by the controller, 152, of the supplementary atomizing gas compressor, 150, responsive to the pressure sensor, 153, of contactor chamber pressure. Gas compressor intercoolers, and a final gas cooler, 154, can be used to maintain a low temperature of the carbon dioxide gas going in to the contactor chamber, in order to improve gas solubility into the continuous water phase of the slurry fuel. Contactor chamber and common rail pressure is to be essentially equal to fuel injection pressure.
(7) Slurry fuel injection into each engine combustion chamber starts when the fuel injection valve is opened by the electronic timer unit, 137, and ends when the fuel shutoff valve is closed by the electronic timer unit, 137.
   The Combined Double Valve Fuel injector

A cross sectional drawing of an example combined double valve fuel injector is illustrated schematically in FIG. 1. The piston cylinder and spring driver, 1, opens and closes the fuel injection valve, 2, via the fuel injection valve shaft, 3. A separate piston cylinder and spring driver, 4, opens and closes the fuel shutoff valve, 5, via the fuel shutoff valve shaft, 6.

These elements are sealably enclosed within the stationary fuel injector body, 11. High pressure slurry fuel, containing dissolved atomizing gas in the continuous phase, enters the fuel manifold, 7, via the slurry fuel connector, 8, from a high pressure slurry fuel common rail, and flows into the intershaft fuel flow passage, 9, via fuel passages, 10.

Admission of high pressure hydraulic fluid, from a hydraulic fluid common rail, via connection, 12, to the opening aide, 13, of the fuel shutoff valve driver piston, 4, opens the fuel shutoff valve, 5, against the driver spring, 4, and admits high pressure slurry fuel to the fuel injector valve, 2.

Subsequent admission of high pressure hydraulic fluid, from the hydraulic fluid common rail, via connection, 14, to the opening side, 15, of the fuel injection valve driver piston, 1, opens the fuel injection valve, 2, against the driver spring, 1, and admits high pressure slurry fuel to the fuel injection nozzle, 16, and from there into the engine combustion chamber, 17.

Adjustable venting of hydraulic fluid from the opening side, 13, of the fuel shutoff valve driver piston, 4, via connection, 12, allows the driver spring, 4, to close the shutoff valve, 5, against a back seat, 18, on the fuel injection valve head, 19, and slurry fuel flow to the fuel injection valve, 2, and hence into the engine combustion chamber, 17, is stopped. The time interval between a fixed opening time of the fuel injection valve, 2, and the subsequent adjustable closing of the fuel shutoff valve, 5, can be varied as a method of adjusting the fuel quantity injected into the engine combustion chamber during each engine cycle, in order to adjust engine torque output.

The opening lift of the fuel shutoff valve, 5, is to be appreciably greater than the opening lift of the fuel injection valve, 2, so that opening of the fuel injection valves does not close the fuel shutoff valve.

Subsequent venting of hydraulic fluid from the opening side, 15, of the fuel injection valve driver piston, 1, via connection, 14, allows the driver spring, 1, to close the fuel injection valve, 2. The fuel shutoff valve, 5, remains closed while moving down with the closing fuel injection valve head, 19, to force essentially all slurry fuel out of the bottom of the fuel injector, beyond the fuel shutoff valve. The clearance between the lower end, 20, of the fuel shutoff valve, 5, and fuel injector body, 11, when the fuel injection valve is closed, is finite but small. The two valve seating areas on the fuel injection valve head, 19, share a common outer radius, 21. With these arrangements, essentially the only slurry fuel undergoing depressurization, and the needed supplementary atomization due to expansion of atomizing gas out of the continuous phase, is that slurry fuel injected into the diesel engine combustion chamber, 17.

A pintle type fuel injection nozzle, 16, is shown in FIG. 1, but other types of fuel injection nozzle can be used, such as multiple fuel injection nozzles.

Driver spring chambers are vented to atmosphere via vents, 22, and hydraulic fluid leakage is collected and returned via connections, 23, to the hydraulic fluid reservoir. Similarly slurry fuel leakage is returned via connections, 24, to the slurry fuel tank.

### Bosch Igniter Fuel Injection System

An example of the well known Bosch igniter fuel injector system is shown schematically on FIG. 2, and comprises the following elements:
a) The transfer pump, 56, transfers igniter fuel, at moderate pressure, from the igniter fuel tank, 57, to the fuel manifold on the Bosch igniter fuel pump, 58.
b) The two stroke cycle, four cylinder diesel engine, 59, has one Bosch igniter fuel injector, 60, for each engine combustion chamber.
c) The Bosch igniter fuel pump, 58, has four separate injection pumps, 61, 62, 63, 64, each of which delivers igniter fuel, at high pressure, to but one Bosch fuel injector, during the compression stroke of the engine piston. For this two stroke cycle diesel engine, 59, the Bosch igniter fuel pump cams are driven directly from the engine crankshaft, 65.
d) The transfer pump, 56, can also be driven by the engine crankshaft or separately by an electric motor.
e) The igniter fuel quantity delivered into each engine combustion chamber during each compression stroke is adjustably set by the igniter fuel quantity control, 66, to be described hereinbelow.

Details of an example Bosch igniter fuel injector, 60, are shown schematically on FIG. 3, and comprise the following elements:
f) The injection valve, 67, is closed against its seat, 68, by the spring, 69.
g) The injection valve, 67, is opened when igniter fuel is delivered at high pressure, from the connected igniter fuel pump, 64. The igniter fuel pressure acts on the extra outer area, 71, of the injection valve, 67, to overcome the closing force of the spring, 69, and igniter fuel is then injected into the engine combustion chamber, 70, during each compression stroke.
h) The igniter fuel injection valve, 67, is closed when the igniter fuel pump, 64, stops delivering igniter fuel and drops the pressure to pump manifold pressure as described hereinbelow.

Details of an example single Bosch igniter fuel pump, 64, are shown schematically on FIGS. 4 and 5, as modified for this invention, and comprise the following elements:
i) The igniter fuel pump plunger, 72, is moved through a fixed upward stroke length, inside the closely fit stationary pump barrel, 73, by the pump cam, 74, via the roller cam follower, 75, and engine crankshaft, 65. The plunger return spring, 76, between the fuel pump plunger, 72, and roller cam follower to the retracted position of each plunger stroke after each igniter fuel injection.
j) The transfer pump, 56, delivers igniter fuel into the fuel manifold, 77, via the connection, 79, and into the'pump barrel, 73, when the pump plunger, 72, is fully retracted, and the fuel inlet port, 81, and fuel spill port, 82, are uncovered by the plunger top.
k) As shown in more detail on FIG. 5, igniter fuel delivery to the igniter fuel injector, 60, and hence igniter fuel injection into the engine combustion chamber, commences when the rising plunger top, 83, covers both the fuel inlet port, 81, and the fuel spill port, 82, and ends when the fuel spill port, 82, is subsequently uncovered by the helical curved top edge, 84, of the reduced plunger diameter portion, 85. Igniter fuel above the plunger top is released via the slot, 86, and fuel spill port, 82. Igniter fuel injection into the engine combustion chamber thus occurs only during that fuel delivery portion of the plunger stroke when the fuel spill port, 82, is covered by that portion of the plunger, 72, between the plunger top, 83, and the helical curved top edge, 84, of the reduced diameter plunger portion, 85. And this fuel delivery portion of the plunger stroke can be adjusted by rotating the plunger, 72, within the pump barrel, 73, via the geared control sleeve, 87, keyed to the pump plunger, 72, via the key, 88. The geared control sleeve, 87, can be rotated by the control rack, 89.
l) During the fuel delivery portion of the plunger stroke, igniter fuel is delivered to the igniter fuel injector, 60, via the delivery check valve, 90, and the injector fuel inlet, 91, and opens the injection valve, 67, when igniter fuel pressure, acting on the extra outer area, 71, of the injection valve, creates a force exceeding the closing force of the spring, 69. In this way an adjustable igniter fuel quantity is injected into each diesel engine combustion chamber during each compression stroke.
m) When the slot, 86, is aligned with the fuel spill port, 82, the fuel delivery portion of the plunger stroke is zero and no igniter fuel is injected into the engine combustion chamber.
   For the purpose of this invention the helical curved top edge, 84, of the reduced plunger diameter portion, 85, is modified as follows:
n) During normal running of the engine only a small igniter fuel quantity is to be injected into the combustion chamber during each compression stroke. For this operation, the short fuel delivery portion, 92, of the helical top edge, 84, is aligned to the fuel spill port, 82, and is of a constant width, 93, somewhat greater than the diameter of the fuel spill port, 82.
o) During cold starting of the engine, a larger igniter fuel quantity is needed to overcome engine friction and start the engine and hence a longer fuel delivery portion, 94, of the plunger stroke is needed, to be aligned with the fuel spill port, 82, during engine cold starting, as shown on FIG. 5.

The Bosch type igniter fuel injection system, illustrated on FIGS. 2, 3, 4 and 5, and described hereinbelow, is an illustrative example, and any of the various alternative Bosch type fuel injection systems, such as the single plunger distributor systems, can be used for the purposes of this invention.

### Common Rail Igniter Fuel Injection System

An example common rail igniter fuel injection system is shown schematically in FIGS. 6 and 7, and comprises the following elements:
a) The igniter fuel pump, 32, driven by the engine crankshaft, 37, transfers igniter fuel from the supply tank, 33, at high pressure into the igniter fuel common rail, 34. The common rail pressure sensor, 35, and pump control, 36, adjust the igniter pump flow rate to maintain an essentially constant igniter fuel common rail pressure, appreciably greater than the maximum pressure in the engine combustion chamber, and essentially equal to igniter fuel injection pressure.
b) The two stroke cycle, four cylinder, diesel engine, 38, has at least one common rail igniter fuel injector, 39, for each engine combustion chamber.
c) Each igniter fuel common rail fuel injector comprises an igniter fuel injection valve, 40, opened and closed by a piston cylinder, and spring driver, 41, as shown on FIG. 7. The igniter fuel injection valve, 40, is opened by applying igniter fuel pressure from the igniter fuel common rail, 34, via connection, 44, to the opening side, 42, of the driver piston, 41, via the solenoid and spring operated pressure and vent opener valve, 43, when the opener solenoid, 45, receives electric power from an electric power source. The igniter fuel injection valve, 40, is closed when the opening side, 42, of the driver piston, 41, is vented to the fuel tank, 33, via connection, 46, by the driver spring, 47, whenever electric power is turned off from the opener solenoid, 45, as shown on FIG. 7.
d) Igniter fuel at common rail pressure is supplied to the igniter fuel injection valve, 40, via the connection, 48, to the supply pressure and vent valve, 49, and the pressure connection, 50, of the solenoid and spring operated pressure and vent supply valve, 49, to the igniter fuel common rail, 34, whenever the supply solenoid, 51, receives electric power from an electric power source. Igniter fuel pressure at the igniter fuel injection valve, 40, is vented to fuel tank, 33, pressure via connection, 52, by the driver spring, 53, whenever electric power is turned off from the supply solenoid, 51, as shown on FIG. 7.
e) An example electric timer for controlling the crank angle time igniter fuel injection starts into the engine combustion chamber, during each compression stroke, and for adjusting the duration of igniter fuel injection, and hence the igniter fuel quantity injected during each engine cycle, is shown schematically on FIG. 8, and operates as follows for a two stroke cycle diesel engine:
   Electric power from the power source, 54, reaches the opener solenoid, 45, and the supply solenoid, 51, concurrently via the start switch, 55, and the stop switch, 95, in series.
   The start cam, 96, closes the stationary start switch, 55, whenever the switch cam follower, 97, is on the raised section, 98, of the start cam, 96. The start cam, 96, is rotated by the engine crankshaft, 37, and start key, 99, so that igniter fuel injection into the engine combustion chamber occurs during each compression stroke and prior to injection of slurry fuel thereinto. The start switch, 55, is closed when the start switch cam follower, 97 returns to the start cam base circle, 105.
   The stop cam, 100, opens the angularly adjustable stop switch, 95, whenever the stop switch cam follower, 101, is on the raised section, 102, of the stop cam, 100. The stop cam, 100, is rotated by the engine crankshaft, 37, and stop key, 103, so that igniter fuel injection into the engine combustion chamber is stopped an adjustable injection time interval after injection was started. This injection time interval is adjusted by rotating the stop switch, 95, angularly about the crankshaft, 37, centerline. The stop switch, 95, is subsequently closed when the stop switch cam follower, 101, returns to the stop cam base circle, 104, prior to the next closing of the start switch, 55.
   In this way the engine operator can adjust the duration of igniter fuel injection and hence the igniter fuel quantity injected into each engine combustion chamber during each engine cycle, by angularly adjusting the position of the stop switch, 95, via the control lever, 106. During normal engine operation only a small igniter fuel quantity is to be injected into the combustion chamber during each compression stroke. However, during cold starting of the engine sufficient igniter fuel is to be injected into each engine cycle, as needed to overcome engine friction and start the engine. When the engine is to be stopped the stop switch, 95, is positioned to open concurrently with closing of the start switch, 55, and no igniter fuel is injected into the engine combustion chamber.
   Each engine cylinder has separate start and stop switches, and these are distributed around the same opener cam and stop cam.

The common rail igniter fuel injection system, illustrated on FIGS. 6, 7 and 8, and described hereinabove is an illustrative example, and any of the various alternative common rail fuel injection systems can be used for the purposes of this invention.

### Industrial Uses of the Invention

Several combinations of preatomized fuel particles, suspended in a continuous phase containing dissolved supplementary atomizing gas, can be efficiently used as fuel for small and medium bore diesel engines, operated at high to medium speed, by use of the slurry fuel injection systems of this invention. The following examples illustrate several of these slurry fuel combinations.
1) Residual petroleum fuel particles, suspended in a continuous water phase, with a small portion of high cetane number distillate petroleum igniter fuel particles, and using carbon dioxide, or air, or diesel engine exhaust, or oxygen as supplementary atomizing gas.
2) Tar fuel particles from Athabaska tar sands, suspended in a continuous water phase, with a small portion of high cetane number distillate petroleum igniter fuel particles, and using carbon dioxide, or air, or diesel engine exhaust, or oxygen as supplementary atomizing gas.
3) Coal tar fuel particles from coke ovens, suspended in a continuous water phase, with a small portion of high cetane number distillate petroleum igniter fuel particles, and using carbon dioxide, or air, or diesel engine exhaust, or oxygen as supplementary atomizing gas.
4) Biomass tar fuel particles from the destructive distillation of non food farm harvest biomass material, suspended in a continuous water phase, with a small portion of high cetane number distillate petroleum igniter fuel particles, and using carbon dioxide, or air, or diesel engine exhaust, or oxygen as supplementary atomizing gas.
5) Finely shredded non food farm harvest biomass charcoal particles suspended in a continuous distillate petroleum fuel phase, such as number two diesel fuel; and using methane, or natural gas, as supplementary atomizing gas.

Some risk of explosion, internal to the slurry fuel common rail, the contactor chamber, and the fuel injectors, may exist when using supplementary atomizing gas containing oxygen, such as air, and particularly when using moderate purity oxygen gas.

Apparatus for preparing several of these slurry fuels is described in my following US patent applications, now on file in the US Patent and Trademark Office.
a) U.S. patent application Ser. No. 11/796,714, entitled, Rotary Residual Fuel Slurrifier, filed 30 Apr. 2007.
b) U.S. patent application Ser. No. 12/583,448, entitled, Rotary Tar Slurrifier, filed 21 Aug. 2009.
c) U.S. patent application Ser. No. 12/454,640, entitled, Engine Fuels from Coal Volatile Matter, filed 21 May 2009.
d) U.S. patent application Ser. No. 12/590,333, entitled Cyclic Batch Coal Devolatilization Apparatus, filed 6 Nov. 2009.
e) U.S. patent application Ser. No. 12/653,189, entitled Engine Fuels from Coal and Biomass Volatile Matter, filed 10 Dec. 2009.

This material is incorporated herein by reference thereto.

The residual fuel content of newly discovered crude oils has tended to increase with the passage of time. Indeed some large new oilfields, such as the Athabaska tar sands, yield a crude oil which is essentially wholly residual fuel. Distillate petroleum fuels can be prepared from these residual and tar fuels, but substantial fuel and energy losses result. Direct use of residual fuels in transportation engines currently require use of expensive distillate petroleum fuels, which are increasingly in reduced supply.

Preatomization of residual fuels, tars from tar sands, and tars from coal and biomass, into a suspension of very small fuel particles in a continuous water phase, is a promising method for efficiently using these fuels in small and medium bore, high and medium speed, diesel engines, which are the major source for our critical transportation industry. A major step toward the energy independence needed for a sound national defense can be achieved in this way.

Having thus described my invention, what I claim is:

1. An improved combination of a diesel engine with a common rail slurry fuel injection system for injecting slurry fuels, containing supplementary atomizing gas dissolved into the continuous phase of the slurry, into each combustion chamber of the diesel engine, and comprising:
a diesel engine comprising an integral number of separate piston and cylinder units, each of which compressibly enclose a combustion chamber, said pistons being reciprocated within said cylinders by an engine crankshaft, each said diesel engine which operates on a four piston strokes cycle additionally comprising a camshaft;
a source of slurry fuel comprising many fuel particles suspended in a continuous liquid phase;
a source of supplementary atomizing gas, at high pressure, at least some portions of which are soluble in said continuous phase of said slurry fuel;
a source of high pressure hydraulic fluid and a receiver of hydraulic fluid;
said common rail slurry fuel injection system comprising:
(1) a number of separate combined double valve slurry fuel injectors, each combustion chamber of said diesel engine being fitted with at least one combined double valve slurry fuel injector, each said combined double valve fuel injector comprising, a slurry fuel injection valve and driver means for opening and closing said fuel injection valve, a separate slurry fuel shutoff valve and driver means for separately opening and closing said fuel shutoff valve;
each said combined double valve fuel injector comprises fuel injector body with a fuel injection nozzle, a fuel injection valve for admitting fuel flow to said fuel injection nozzle when open, and for stopping fuel flow to said fuel injection nozzle when closed, a fuel shutoff valve for admitting fuel flow to said fuel injection valve when closed, a fuel shutoff valve for admitting fuel flow to said fuel injection valve when open, and for stopping fuel flow to said fuel injection valve when closed;
said fuel injection valve comprising a fixed valve seat on the fuel injection body, a moveable valve seat on a fuel injection valve head, said fuel injection valve head being secured to one end of a moveable fuel injection valve shaft, said fuel injection valve being closed whenever said fixed valve seat and said moveable valve seat are forced together by said fuel injection valve shaft, and being open whenever said fixed valve seat and said moveable valve seat are pulled apart by said fuel injection valve shaft;
said fuel shut off valve comprising a moveable valve seat on the fuel injector valve head, and another moveable valve seat on a fuel shut off valve shaft, said fuel shut off valve shaft being sealably operable within said fuel injector body, and said fuel injection valve shaft being sealably operable within said fuel shut off valve shaft;
wherein the two separate moveable valve seats on the fuel injection valve head have a common outer radius; and the outer radius of the fuel shut off valve shaft is greater than the common outer radius of the two separate moveable valve seats on the fuel injection valve head, in order to create a fuel flow path past the common outer radius of the two valve seats on the fuel injection valve head;
wherein an intershaft fuel flow passage exists between the lower portion of the fuel shut off valve shaft and the lower portion of the fuel injection valve shaft and the head thereof;
said fuel injector body further comprising a slurry fuel connector and a fuel flow passage from said connector to a fuel manifold surrounding a portion of said fuel shut off valve shaft;
wherein said fuel shut off valve shaft comprises one or more fuel passages between said intershaft fuel flow passage and said fuel manifold and said fuel manifold is sufficiently wide in the direction of motion of said fuel shut off valve shaft, that a fuel flow connection always exists between said fuel manifold and said intershaft fuel flow passage via said one or more fuel passages;
whereby a fuel flow path is created so that: whenever both the fuel injector valve and the fuel shut off valve are open between their seats, fuel can flow from said slurry fuel connector, into said intershaft fuel flow passage, via said fuel manifold, and from said intershaft fuel flow passage into said fuel injection nozzle and the engine combustion chamber, via said open fuel shut off valve, followed by said open fuel injection valve; and further so that whenever the fuel shut off valve is closed between its two moveable seats, fuel cannot flow from said slurry fuel connector via said fuel flow path, into said fuel injection nozzle and the engine combustion chamber;
each double valve slurry fuel injector further comprising, piston, cylinder, and spring slurry fuel injection valve driver means for opening and closing said fuel injection valve, via said slurry fuel injection valve shaft, wherein said driver piston is secured to said fuel injector valve shaft, and said driver spring acts on the vented closing side of said driver piston to close said fuel injection valve, and high pressure hydraulic fluid, from said source of high pressure hydraulic fluid, can act on the opposite, opening side of said driver piston to open said fuel injection valve, said high pressure hydraulic fluid being admitted into the opening side of said driver piston, from said source of high pressure hydraulic fluid, via a fuel injection valve pressure and vent valve, with pressure and vent connections and an operator, so that when said fuel injection valve pressure and vent valve is open to the pressure connection, high pressure hydraulic fluid can flow onto the opening side of said driver piston to open said fuel injection valve, and when said fuel injection valve pressure and vent valve is open to the vent connection, hydraulic fluid can be forced out of the pressure side of said driver piston by said spring, to close said fuel injection valve, and to return said hydraulic fluid to said receiver of low pressure hydraulic fluid;
each double valve slurry fuel injector further comprising piston, cylinder, and spring slurry fuel shut off valve driver means for opening and closing said fuel shut off valve, via said slurry fuel shut off valve shaft, wherein said driver piston is secured to said slurry fuel shut off valve shaft, and said driver spring acts on the vented closing side of said driver piston to close said fuel shut off valve, and high pressure hydraulic fluid, from said source of hydraulic fluid, can act on the opposite opening side of said driver piston to open said fuel shut off valve, said high pressure hydraulic fluid being admitted into the opening side of said driver piston, from said source of high pressure hydraulic fluid, via a slurry fuel shut off valve, pressure and vent valve, with pressure and vent connections and an operator, so that, when said fuel shut off valve pressure and vent valve is open to the pressure connection, high pressure hydraulic fluid can flow onto the opening side of said driver piston to open said fuel shut off valve, and when said fuel shut off valve pressure and vent valve is open to the vent connection, hydraulic fluid can be forced out of the pressure side of said driver piston, by said spring, to close said fuel shut off valve;
wherein the net opening force created by said piston, cylinder, and spring driver of said slurry fuel injection valve, is greater than the net closing force created by said piston, cylinder, and spring driver of said slurry fuel shut off valve;
wherein the operators of said fuel shutoff valve driver pressure and vent valve and said fuel injection valve driver pressure and vent valve is one chosen from the group of pressure and vent valve operators consisting of mechanical cam and return spring operators; solenoid opener and separate solenoid closer operators; solenoid opener and spring closer operators; piezoelectric opener and closer operators;
a timer means for separately operating the driver means of said fuel injection valve, and the driver means of said fuel shutoff valve, said timer means being operated by the crankshaft of two stroke cycle diesel engines and being operated by the camshaft of four stroke cycle diesel engines;
said timer means separately operates the pressure and vent valves of said fuel injection valve, and said fuel shutoff valve so that:
the slurry fuel shut off valve is opened before the slurry fuel injection valve is opened;
the slurry fuel injection valve is opened at or near to best fuel efficiency timing for the diesel engine cycle;
the slurry fuel shut off valve is adjustably closed before the slurry fuel injection valve, to control the quantity of slurry fuel injected per diesel engine cycle, in order to control engine torque;
the slurry fuel injection valve is closed after the closing of the slurry fuel shut off valve;
whereby essentially the only slurry fuel being depressurized, during each slurry fuel injection, is that injected into the engine combustion chamber, where this depressurization created needed supplementary atomization, and only trace quantities of depressurized fuel are left behind in the fuel injector, and further whereby slurry fuel is not used for driving the fuel injection system, and compressed supplementary atomizing gas is not lost in this operation;
said diesel engine further comprising a high pressure slurry fuel common rail system comprising: a high pressure slurry fuel common rail with high pressure slurry fuel connections to each said slurry fuel connector of each said slurry fuel injector; a contactor chamber for contacting supplementary atomizing gas with slurry fuel so that at least some portions of said supplementary atomizing gas are dissolved at high pressure into the continuous phase of the slurry fuel; a high pressure engine driven slurry fuel pump for transferring slurry fuel, from said slurry fuel source into said contactor chamber at high contactor chamber pressure; means for transferring supplementary atomizing gas, from said source of high pressure supplementary atomizing gas, into said contactor chamber at high pressure; means for transferring slurry fuel, containing dissolved supplementary atomizing gas, from said contactor chamber into said common rail without a decrease of pressure; said high pressure in said slurry fuel common rail being essentially equal to the maximum pressure of fuel injection into said diesel engine combustion chamber; said high pressure in said contactor chamber being appreciably greater than the maximum pressure reached in said diesel engine combustion chamber, but no greater than the high pressure in said slurry fuel common rail;
said diesel engine further comprising a high pressure hydraulic fluid common rail system comprising:
a hydraulic fluid common rail; an engine driven hydraulic fluid pump for transferring hydraulic fluid, from said hydraulic fluid source, and pumping it at high pressure into said hydraulic fluid common rail; high pressure hydraulic fluid connections, from said hydraulic fluid common rail, to each said fuel injection valve pressure and vent valve pressure connection and to each said fuel shut off valve pressure and vent valve pressure connection, of each said double valve slurry fuel injector; wherein said high pressure in said hydraulic fluid common rail is sufficient in combination with the pistons and springs of the driver means of said fuel injection valves and said fuel shut off valves to open said combined double valves in each said slurry fuel injector;
wherein said receiver of hydraulic fluid is said hydraulic fluid source and further comprises low pressure hydraulic fluid connections to each said fuel injection valve pressure and vent valve vent connection, and to each said fuel shut off valve pressure and vent valve vent connection, of each said double valve slurry fuel injector, so that hydraulic fluid released from said opening side of said driver pistons, during closure of said fuel injection valve, and during closure of said fuel shut off valve, is returned to said hydraulic fluid source;
wherein the improvement comprises adding to said combination of a diesel engine with a common rail slurry fuel injection system, a separate igniter fuel injection system for injecting high cetane number distillate igniter fuel into each engine combustion chamber of said diesel engine during each compression stroke and prior to the injection of slurry fuel thereinto, said igniter fuel injection system comprising:
a separate source of high cetane no. distillate igniter fuel;
an igniter fuel injector comprising: an igniter fuel nozzle; an igniter fuel injection valve with means for opening and closing said igniter fuel injection valve;
igniter fuel pump and piping means for transferring igniter fuel from said separate source of igniter fuel to said igniter fuel injector at a high pressure appreciably greater than the maximum pressure in said diesel engine combustion chamber;
igniter fuel timer and control means for timing the injection of igniter fuel into the diesel engine combustion chamber to take place during each compression stroke and prior to the injection of slurry fuel thereinto, said igniter fuel timer and control means being operated by the crankshaft of two stroke cycle diesel engines and being operated by the camshaft of four stroke cycle diesel engines;
control means for controlling the quantity of igniter fuel injected into each diesel engine combustion chamber during each engine cycle, so that—
a cold engine starting igniter fuel quantity can be injected into each engine combustion chamber, during engine startup, the burning of which creates sufficient engine power to cold start the diesel engine;
a running engine igniter fuel quantity, appreciably smaller than said cold engine starting igniter fuel quantity, can be injected into each engine combustion chamber, during normal engine running, to improve ignition and combustion of the slurry fuel quantity subsequently injected into each engine combustion chamber.

2. An improved combination of a diesel engine with a common rail slurry fuel injection system, as described in claim 1, wherein the improvement comprises adding a separate Bosch igniter fuel injection system for injecting high cetane number igniter fuel at high pressure into each engine combustion chamber of said diesel engine, during each compression stroke, and prior to the injection of slurry fuel thereinto, said Bosch igniter fuel injection system comprising:
at least one Bosch fuel injector means for each said combustion chamber of said diesel engine, for delivering atomized igniter fuel into said combustion chamber, each said Bosch fuel injector comprising a nozzle and an injector valve;
said injector valve being opened by igniter fuel pressure acting on non seating extra valve area on the moveable valve element, said injector valve being closed by a spring which always acts on said moveable valve element in a closing direction, whenever igniter fuel pressure is not acting on this extra valve area, said igniter valve delivers atomized igniter fuel into the engine combustion chamber, via said nozzle, whenever open;
each Bosch fuel injector being flow connected into a Bosch fuel pump means for delivering igniter fuel, at high pressure, to said Bosch fuel injector;
transfer pump means for transferring igniter fuel from said source of igniter fuel to a sump on said Bosch fuel pump;
said Bosch fuel pump comprising a pump plunger, sealably operative within a stationary pump barrel, and operated through a fixed plunger stroke length by an igniter fuel pump cam driven from the diesel engine crankshaft of a two stroke diesel engine, and from the camshaft of a four stroke cycle diesel engine;
said stationary pump barrel comprising an igniter fuel inlet port, connecting via the sump to said igniter fuel transfer pump, and a spill port connecting to said sump;
said pump plunger further comprising a helical reduced diameter portion, and a slot from the top of the plunger to the bottom of said reduced diameter portion, said helical portion operative to close said spill port in said pump barrel only during an adjustable fuel injection portion of each plunger stroke; said pump plunger opening said igniter fuel inlet port only at the bottom portion of said plunger stroke, said fuel injection portion of each plunger stroke being adjusted by rotating the pump plunger, and its helical portion, via a gear and rack connecting to the engine torque controller, so that the duration of igniter fuel injection, and hence the igniter fuel quantity injected into each engine cycle, can be adjusted by adjusting the gear and rack to rotate the helical portion of the plunger;
whereby during normal engine running on slurry fuel, a small quantity of igniter fuel can be injected, atomized, and burned in each engine combustion chamber, and the resulting hot gases will promote evaporation and thermal cracking of the fuel particles in the subsequently injected slurry fuel, and thus improve the speed and efficiency of burning of the fuel components in the slurry fuel:
and further whereby, during cold starting of the engine, a sufficient quantity of igniter fuel can be injected into the engine combustion chamber, the combustion and energy release thereof being sufficient to overcome engine friction and the engine can thus be started.

3. An improved combination of a diesel engine with a common rail slurry injection system, as described in claim 1, wherein the improvement comprises adding a separate igniter fuel common rail fuel injection system for injecting high cetane number distillate igniter fuel, at high pressure, into each engine combustion chamber of said diesel engine, during each compression stroke, and prior to the injection of slurry fuel thereinto, said igniter fuel common rail fuel injection system comprising:
a high pressure igniter fuel common rail supplied with igniter fuel at high pressure from an igniter fuel source, by a high pressure igniter fuel pump and pump control;
an igniter fuel injector comprising a nozzle, flow connected to an igniter fuel injection valve, a piston, cylinder and spring driver for opening and closing said igniter fuel injection valve, said igniter fuel injection valve having a supply side where igniter fuel can be supplied to the inlet of the igniter fuel injection valve;
a first solenoid and spring operated opener pressure and vent valve for connecting the opening side of the igniter fuel injection valve driver piston to high pressure igniter fuel, via a pressure connection from said igniter fuel common rail, when said igniter fuel injection valve is to be opened; and for connecting the opening side of the igniter fuel injection valve driver piston to said source of igniter fuel, via a vent return connection, whenever said igniter fuel injection valve is to be closed;
a second solenoid and spring operated supply pressure and vent valve for connecting the supply side of said igniter fuel injection valve to high pressure igniter fuel, via a pressure connection to said igniter fuel common rail whenever said igniter fuel injection valve is to be opened, and for connecting the inlet side of said igniter fuel injection valve to said source of igniter fuel, via a vent return connection, whenever said igniter fuel injection valve is to be closed;
a source of electric power, connected to said solenoids of said first and second solenoid and spring operated pressure and vent valves, via a start switch in series with a stop switch;
said start switch being opened and closed by a start cam, rotated by the engine crankshaft for two stroke cycle engines, and by the camshaft for four stroke cycle engines, said start cam being timed to close said start switch during the engine compression stroke and prior to the injection of slurry fuel into that compression stroke, said start cam being timed to open said start switch late during the next following engine expansion stroke;
said stop switch being opened and closed by a stop cam, rotated by the engine crankshaft for two stroke cycle engines, and by the camshaft for four stroke cycle engines, said stop switch being angularly adjustable about the stop cam rotational centerline, said stop cam being timed to open said stop switch, no earlier than the closing of said start switch, and adjustably later than the closing of said start switch, said stop cam being timed to close said stop switch late during the next following engine expansion stroke;
whereby both the start switch, and the stop switch in series, are concurrently closed only during an igniter fuel flow time interval after closure of the start switch, when both the igniter fuel injection valve is open, and igniter fuel, at common rail pressure, is supplied to the inlet of said igniter fuel injection valve, by the electric power energizing of both solenoid drivers;
and further whereby the igniter fuel flow time interval can be adjusted, to adjust the igniter fuel quantity injected into the engine combustion chamber during each engine cycle;
whereby during normal engine running on slurry fuel, a small quantity of igniter fuel can be injected, atomized and burned in each engine combustion chamber, and the resulting hot gases will promote evaporation and thermal cracking of the fuel particles in the subsequently injected slurry fuel, and thus improve the speed and efficiency of burning of the fuel components in the slurry fuel:
and further whereby, during cold starting of the engine, a sufficient quantity of igniter fuel can be injected into the engine combustion chamber, the combustion and energy release thereof being sufficient to overcome engine friction and the engine can thus be started.
